(19) United States
(12) Patent Application Publication
(10) Pub. No.: US 2020/0068412 A1
(43) Pub. Date: Feb. 27, 2020

(54) METHOD FOR CONTROLLING A WIRELESS COMMUNICATION SYSTEM

(71) Applicant: Robert Bosch GmbH, Stuttgart (DE)

(72) Inventor: Andreas Mueller, Waiblingen (DE)

(21) Appl. No.: 16/548,988

(22) Filed: Aug. 23, 2019

(30) Foreign Application Priority Data
Aug. 24, 2018 (DE) 102018214357.9

(51) Int. Cl. H04W 16/18; H04W 16/22; G01S 17/89

(52) U.S. Cl. CPC H04W 16/18; G01S 17/89; H04W 16/22

(57) ABSTRACT

A method is presented for controlling a wireless communication system in first surroundings. In the process, first pieces of information about actual or planned changes of the first surroundings are ascertained, a future state of the first surroundings is predicted on the basis of the first pieces of information and the wireless communication system is adapted as a function of the predicted future state.

### FIELD OF THE INVENTION

The present invention relates to methods for controlling a wireless communication system or technical units of the communication system, as well as a computer program configured for such purpose.

### BACKGROUND INFORMATION

The topic of networking has grown increasingly in importance in recent times, in particular, in conjunction with developments, such as the “Internet of Things” or “Industry 4.0”. There are many different communication systems such as, for example, cellular mobile communications, wireless LAN, Bluetooth, ZigBee, etc., each of which has been optimized for different application scenarios. There is presently a rapid development in the 5G direction (=5^{th} generation mobile communications), a focus of 5G also including the networking of things (“machine-type communication”) in contrast to earlier generations of mobile communications and, due to the anticipated performance, thus opening up the possibility of many new fields of application. This includes the use of 5G technologies even for critical applications in industry, from applications in autonomous and networked driving, to and including the networking of a large number of sensors, for example, in agriculture or in future “smart cities”. Here it should also be noted that 5G, for example, is more than just an efficient wireless networking technology. Rather, 5G is a comprehensive networking and computing infrastructure, which also includes, among other things, (distributed) cloud solutions (the so-called “Edge Clouds”), provides mechanisms for highly-precise localization and is able to establish numerous application-specific virtual networks on the basis of the underlying technical networking infrastructure.

(Wireless) communication infrastructures are classically largely decoupled from the applications on which they are based, and from the surroundings in which the network is established. This is true, for example, of a WLAN, which is installed in the home, or to a classic mobile communications network, which is installed by a network provider and is intended to network as many customers as possible. In these cases, the network frequently provides only a “best-effort” service and attempts to transmit all data packets as quickly as possible from the transmitter to the receiver, regardless of the state of the application or of the surroundings. The main goal in network planning in these examples is typically to achieve an optimal coverage so that an adequate signal is available, for example, anywhere in the apartment or anywhere in a city. In some cases, the requirements of the applications are taken into consideration with the aid of a differentiation of various traffic classes/priority classes, to and including reserving network resources along the entire end-to-end connection between transmitter and receiver. Examples of a differentiation of traffic classes or priority classes are the WLAN extension according to the IEEE 802.11e standard or the “DiffServ” approach when transmitting IP packets according to RFC 2474 of the IETF. Examples of an end-to-end reservation of network resources on the other hand are the “IntServ” approach when transmitting IP packets with the aid of the “Resource Reservation Protocol” (RSVP) according to IETF RFC 2210, RFC 2211 and RFC 2212, as well as the current efforts in the direction of “Network Slicing” in conjunction with 5G. In these cases, however, generally only the requirements of individual applications are considered and a consideration of the surroundings does not take place or takes place only to a very limited extent.

### SUMMARY

A method is provided for adapting or controlling a wireless communication system, for example, a 5G network or a WLAN network in surroundings, in particular, in controlled surroundings, i.e., surroundings with pieces of information available about essential elements of the surroundings or about the behavior of the surroundings as such. First pieces of information about actual or planned changes of the surroundings are ascertained and a future state of the first surroundings is predicted on the basis of the first pieces of information. An adaptation or adapted controlling of the wireless communication system then takes place as a function of the predicted future state. Specific examples for controlled surroundings are factories, process engineering plants, agricultural production facilities, etc.

The method presented has the advantage that it is not necessary to respond to changes in a communication system, for example, with respect to the transmission quality of connections, only after they have already occurred due to changes in the surroundings, but that such changes in the surroundings may be predicted at least to a certain degree and that the communication system may be adapted already before the changes occur in such a way that the communication system is able to proactively adjust to the changes in an optimal manner. This may mean, for example, that potential deterioration of the transmission quality of a connection due to changes in the surroundings do not occur in the first place or that in the case of an improvement of the transmission quality of a connection, a portion of the transmission resources actually reserved for this connection may be released, so that these resources may be used, for example, by other communication users.

In this case, dynamic surroundings, i.e., surroundings which may result in a change of the properties (for example, of the transmission quality) of connections as a result of movements and changed locations of elements of the surroundings, such as production machines and processing machines, robots or partially automated vehicles and/or communication users, are particularly relevant. Here, a prediction may be made and the communication system may be suitably adapted using corresponding pieces of status information and pieces of planning information from the surroundings, in particular, from the elements of the surroundings and/or from the communication users or from their applications.

The prediction is advantageously made using stored archived data, from which, for example, typical sequences may be derived and which may thus supplement the instantaneously detected data.

Pieces of information about the communication system, its IT infrastructure or its communication elements or communication units, such as routers, switches or base stations, are advantageously also drawn upon. For example, connection strengths, beam directions or the availability of additional or alternative communication units, such as routers, switches or base stations, may be valuable pieces of information in order to be able to take suitable adaptive measures in the communication system in the event of predicted connection changes.

The methods described herein may be meaningfully used in a wide variety of domains, in particular, in conjunction with controlled surroundings, such as factories, process engineering plants, agricultural production facilities, etc. The use of the methods described increases the scenarios in which an efficient wireless communication system such as, for example, 5G may be used without having to fear adverse effects on applications in the surroundings. This in turn contributes to an increase in the flexibility, mobility and usability of systems in a wide variety of domains. The use is particularly advantageous in industry, as a result of which developments in the direction of Industry 4.0 may be further accelerated and improved upon.

### BRIEF DESCRIPTION OF THE DRAWINGS

FIGS. 1 through 3 schematically show exemplary communication scenarios in changing factory surroundings.

FIGS. 4 and 5 schematically show an exemplary communication scenario, including a moving communication user in factory surroundings.

FIG. 6 schematically shows an exemplary sequence of a method for controlling a wireless communication system.

### DETAILED DESCRIPTION

The highest demands on the underlying networking infrastructure exist for many applications in the context of the “Internet of Things”, of “Industry 4.0” and of comparable fields. Typical examples of this are:
Demands on latency, reliability and availability, for example, for implementing closed-loop control applications in Industry 4.0 or in automated driving.
Demands on the energy efficiency of the terminals, in order to enable a long battery service life, for example, in “Smart Agriculture”.

Existing networking technologies are often not suited or suited only to a very limited degree to meet these demands. At the same time, the potential damage may be major if the networking infrastructure fails to function as desired. A factory at a standstill, for example, because a radio connection was unavailable for a brief period of time, may result in immense damage sums.

While the aforementioned fields of application often involve high demands, there are very specific boundary conditions and controlled or controllable surroundings in many of these application domains. This is true for a factory just as it is for a process engineering plant or for an agricultural production facility and also includes, for example, the following aspects, not all aspects having to be met at the same time:
defined and known structure of the surroundings and detailed configuration of the objects contained therein (for example, machines and equipment in the factory),
time and locale restriction of access by persons,
defined and known structure of a networking infrastructure in the surroundings, possibility of controlling and monitoring a wide variety of objects in the surroundings (for example, machines and equipment, robots or driverless transport systems in a factory),
determination of the services and applications to be utilized at a particular point in time.

This often differs in classic application surroundings of wireless communication systems. Thus, for example, a classic mobile communications provider has only limited influence over how persons in the coverage area move, where they park their cars or what type of services they happen to want to use. In the classic case, therefore, the networking infrastructure is largely “decoupled” from the surroundings, whereas a close coupling suddenly becomes possible, in particular, in the controlled surroundings described (for example, in a factory).

For wireless communication systems, particular challenges arise when networking entities. This is due primarily to the statistical nature of the wireless transmission channel.

In this case, the following effects, in particular, may become relevant:
path loss, i.e., the weakening of the transmission signal on the way from the transmitter to the receiver due to effects such as free field attenuation, diffraction, absorption losses, etc.,
so-called shadow fading, which is caused, in particular, by larger changes of the surroundings, for example, if an object (for example, an automobile) comes between the otherwise existing line-of-sight between transmitter and receiver,
so-called multipath fading, which is caused by microscopic changes in the surroundings (smallest movements, weather, movement of leaves on trees, etc.) and which may result in a rapid change from constructive to destructive interference and vice versa of various propagation paths, in conjunction with potentially strong and rapid fluctuations in the quality of the received signal,
interference, which is caused by other transmissions in the same frequency range, additive noise, for example, thermal noise of the installed components.

As a consequence, the transmission quality potentially changes over time and is a function of the location. In order to enhance the quality and efficiency of the transmission, it is therefore advantageous to appropriately consider the instantaneous state of the transmission channel. Classically, this takes place reactively in such a way that the instantaneous state of the channel between the transmitter and the receiver is ascertained (for example, with the aid of specific channel measuring methods) and, based on this knowledge, the transmission method is then optimized accordingly (for example, with the aid of adaptive modulation and coding, appropriate selection of a multi-antenna method, etc.). However, this optimization typically takes place only within the communication system, without a coupling to or consideration of the surroundings or of the corresponding applications.

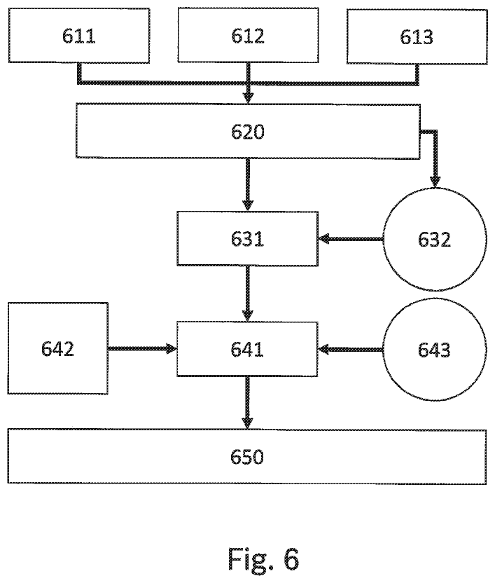

FIG. 6 schematically shows an exemplary sequence of a method for activating or adapting a wireless communication system.

The method roughly includes the following essential blocks:
(1) ascertainment of pieces of context information, pieces of status information and pieces of planning information from the surroundings in steps 611, 612, 613, 620,
(2) prediction of possible future states of the surroundings in the future in step 631,
(3) optimization or adaptation of the communication system or of the networking infrastructure in steps 641 and 650.

The individual steps of the method shown in FIG. 6 are explained in greater detail below.

In a step 620, pieces of context information, pieces of status information and pieces of planning information of the surroundings, as well as additional pieces of information about the network and about the underlying IT system are detected.

They may be ascertained, for example, in preceding steps by surroundings sensors (step 611), by the (networked) devices, as well as by the applications running on them (step 612) or by network systems or IT systems (step 613), and made available to or transmitted to a central instance, i.e., to a central processing unit.

Specific examples of this are:

### (a) Step 611:

Cameras installed in the surroundings detect the position and movements of objects.
Specific localization systems (for example, radio-based methods) determine and provide the positions of particular objects and make these available.
Radar systems/LIDAR systems recognize, for example, if an object approaches a particular location.
A wide variety of sensors ascertains and provides surroundings conditions such as, for example, temperature, weather, humidity, brightness, time of day, etc.

### (b) Step 612:

Mobile devices provide, for example, your instantaneous route planning (to where do I drive next and how, if necessary, including speed, etc.).
Pieces of control information are supplied, from which, for example, it becomes apparent how a robot arm or a motion system is intended to move next.
Pieces of status information about the device such as, for example, battery status, instantaneous connection quality, utilized capacity, etc. are supplied and conveyed.
Pieces of status information about the application(s), for example, which data volumes, which quality of service requirements must soon be expected (for example, if a user starts an augmented reality application on a mobile control panel, it is foreseeable already during the initialization phase that large volumes of data will have to be transmitted a short time later).

### (c) Step 613:

Ascertainment and provision of
state of queues, routing tables, etc.
instantaneous scheduling plans for base stations, etc.
pieces of information regarding instantaneous radio resource management
pieces of information regarding instantaneous link qualities
routinely updated radio maps for observed surroundings

All gathered input parameters are appropriately processed in step 620 (for example, with filtering, fusion of data, plausibility checking, etc.) and then provided for further processing in subsequent step 631. They may also be advantageously archived in a suitable memory in a step 632. It is thus possible to also consider older states and, for example, to further optimize the optimization methods in an adaptive manner.

In a step 631, possible states of the surroundings are predicted based on the provided pieces of context information, pieces of status information and pieces of planning information about the surroundings, as well as, if necessary, based on corresponding pieces of historical information from a database, as well as, if necessary, taking pieces of information about the communication system or about the network infrastructure into consideration. The prediction in this case may advantageously be made in a processing unit, which has access to the memory that includes the received and stored data, and which has at its command sufficient computer resources for a prediction and for deriving measures. The processing unit may be integrated in, or connected to, the communication system. The methods described may be carried out by a computer program, which is executed by the processing unit.

For this purpose as well, it is possible, in general, to include various data sources. The prediction in this case relates, for example, to one or to multiple of the following aspects:
How do the surroundings appear (for example, where are which objects located and how rapidly are they moving)?
How do the (expected) connection qualities appear?
What are potential effects on the applications?

More or less reliable predictions are possible in this case depending on availability and type of input data. If, for example, only camera images of a moving element of the surroundings (for example, of a machine, of a robot or of a vehicle) are available, it is possible with these to then estimate the speed and to extrapolate the movement, though the possibility of a sudden change in speed and/or direction still exists. Historical data may help in this case, if necessary. If, for example, the element of the surroundings turned right at a particular intersection in 90% of the cases in the past, it is quite likely that it will do this again. However, with the advantageous availability of a detailed route planning, a prediction is possible with even far greater reliability. Because of a general residual unreliability of the prediction, the result of the prediction block is therefore advantageously a series of possible future scenarios, which may, if necessary, be linked to a certain probability of occurrence.

In the industrial sector, for example, there is particularly great potential here when control programs are included in the prediction. A robot, for example, often already carries out cyclical activities and, to the extent these are known, this piece of information may be called upon for predicting and thus for adapting or optimizing the communication system overall. In the same way, it is usually permanently defined in the case of a machine tool how exactly the tool will move in order to produce a particular object. Such a piece of information may also be used for predicting and for adapting the communication system.

In step 641, the communication system may be adapted or optimized on the basis of the predicted states (provided with probabilities if necessary). Ascertained or provided network guidelines, for example, prioritizations or requirements from applications of communication users, for example, the required reliability, latency, data rate or availability, may advantageously be taken into consideration in steps 642 or 643.

If various possible future states have been predicted, the communication system may be adapted or optimized, for example, in such a way that only the most probable state is considered (and it is assumed that precisely this is the future state). Alternatively, an adaptation or optimization may also take place, for example, in that an acceptable result is achieved in all most probable states, even if this may be less acceptable, if necessary, if ultimately the most probable state in fact occurs, but optimization to exclusively this state has not occurred.

The communication system is advantageously iteratively adapted or optimized. This means that if a possible strategy has been developed, based on this, the future state is initially again predicted in order to ensure that in that case problems do not arise at another point.

If an overall satisfactory strategy has been found, this strategy is then implemented by suitably adapting, i.e., regulating or activating units 650 of the communication system or of the network infrastructure (including computer and memory infrastructure). An adaptation may, for example, include:
suitable configuration/controlling of base stations, switches and routers, etc.
adaptation of scheduling tables, initiation of handovers, tracking transmission beams/received beams, adaptation of the modulation and coding methods and of other radio resource management functionalities
proactive caching of data near the application (or on the terminal itself) if, for example, a disconnection is expected in the near future
relocation of applications on the network side, for example, from one edge cloud environment to another proactively carrying out a data backup.

In addition to adapting the communication system, it is optionally also possible to adapt units or elements of the surroundings. This may, for example, also include:
triggering warnings if particular problems are expected or are likely unable to be prevented.
controlling of particular objects, for example, to enable a better state detection (for example, zoom with a camera)
controlling of possible auxiliary devices to avoid connectivity problems or the like. Special alignable “reflectors” capable of producing a high signal quality between two nodes, even if there is no direct line-of-sight, or the temporary use of flight drones as a relay to compensate for possible connection problems, for example, would be conceivable here.

In addition to adapting the communication system, it is optionally also possible to adapt networked devices and their applications. This may, for example, also include:
adaptation of control and regulating algorithms (for example, path planning of a robot arm, deceleration or acceleration of a movement, etc.).
adaptation of the route planning of mobile devices.
establishment of connections to an alternative system (for example, in the event of 5G network problems, establishing a WLAN connection).
establishment of redundant connections (“multi-link-connectivity”).

Specific exemplary embodiments are considered below, in which a radio system (for example, 5G) in a factory is to be adapted or optimized. The mechanisms described are accordingly also transferrable to other communication systems and to other surroundings.

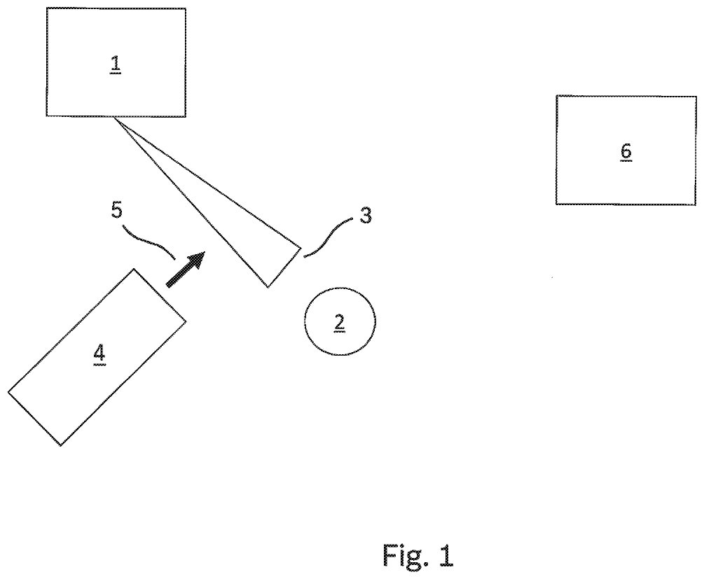

FIG. 1 shows a configuration that includes a communication user 2, which is connected to a base station 1 via a (schematically shown) connection 3. The communication user may be any device having a suitable communication interface for wireless communication. In factory surroundings, this may, for example, be a production machine or processing machine, or also a device for augmented reality applications for a user such as, for example, data goggles. Another base station 6 is, in principle, also in range, but to which there is (yet) no connection. In the surroundings, here in the factory, a unit or an element of the surroundings (infrastructure element) is moving 4, for example, a fork lift, whose instantaneous route planning 5 intersects the direct line-of-sight between communication user 2 and base station 1. There is therefore the risk that the connection between base station 1 and communication user 2 is interrupted or is at least no longer good enough if the unit, for example, the fork lift, adheres to its planned route 5. If this were perhaps still manageable in an augmented reality application and affected only the “quality of experience”, it could then also be definitely critical if communication user 2 is, for example, a mobile operating device with safety functions (for example, emergency stop) or a critical machine, since an interruption of the connection may result in an undesired emergency shutdown and thus to a production stop.

In the methods provided, the intention is to initially identify the problem, in order to then be able to develop and implement corresponding potential solutions. The basis for this may be corresponding pieces of context information, pieces of status information, and pieces of planning information from the surroundings, from the applications, from the network as well as from the objects involved. Specifically, this could be, in particular, the following pieces of information:
route planning of the unit, for example, of the fork lift: in the case of autonomously driving fork lifts, this could be obtained directly from the application, in the case of person-driven lifts, this could be the route then being displayed to the forklift driver.
pieces of connection information (communication user 2 and base station 1) may be obtained as pieces of information from the communication system or communication network.
the location of communication user 2 may be determined with the aid of suitable localization methods (for example, integrated into the communication system or in the communication user), with the aid of cameras and of other surroundings sensor systems or on the basis of organizational measures or pieces of surroundings or infrastructure information, since it is known, for example, that this communication user is always, or when utilizing the current application or at this point in time, located in a particular position.

These pieces of information may be generally available in controlled surroundings such as, for example, in a factory. Based on this, it is then possible to identify the problem (=prediction of the probable future state) and to develop and implement a corresponding corrective measure.

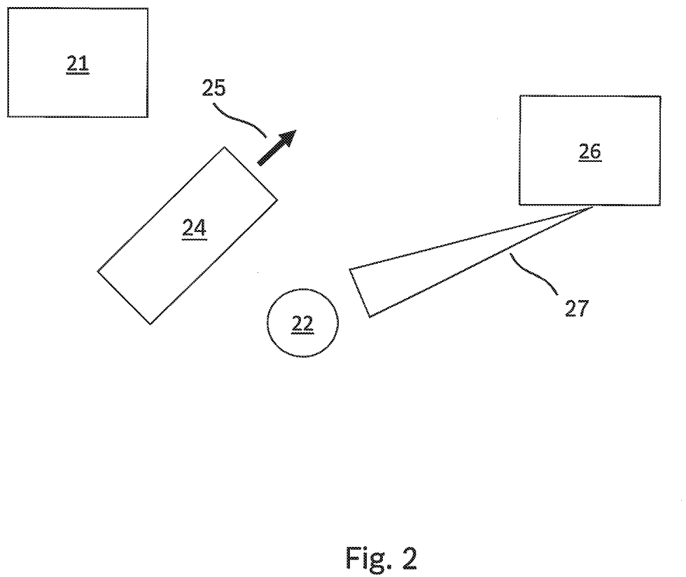

One example of this is shown in FIG. 2. Alluding to the scenario in FIG. 1, the line-of-sight between communication user 22 and base station 21 is disrupted by a route 25 of a unit 24. This is predicted as a (potential) problem as described in FIG. 1 already before the disruption occurs and may also be proactively prevented already before it occurs by a handover of connection 27 of communication user 22 with the network of base station 21 to base station 26. As a result, unit 24 is able to adhere to its travel route 25 without the connection being interrupted.

In addition to this adaptation of the communication system based on pieces of surroundings information, it is optionally also possible to adapt the surroundings or their infrastructure units.

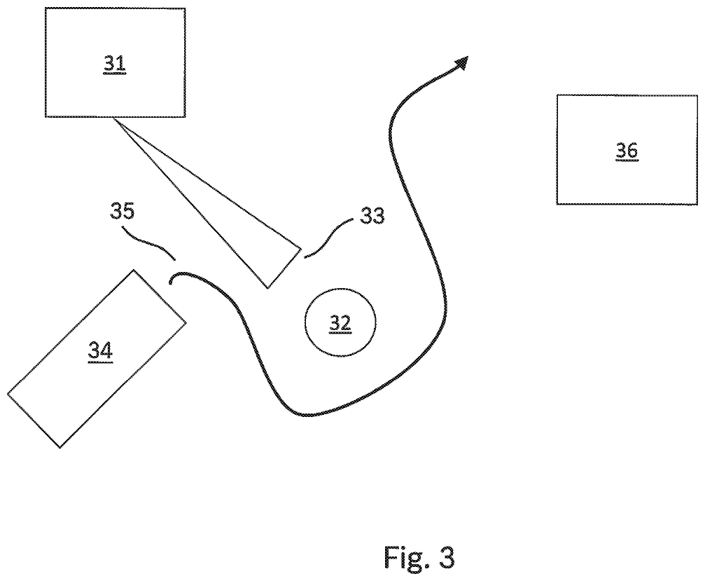

Based again on the scenario described in FIG. 1, it is shown in FIG. 3 how the surroundings or one of its elements may be adapted or optimized in response to the predicted problem. Here, a connection 33 between a communication user 32 and a base station 31 is again jeopardized by an originally planned route (not shown) of a unit 34. There is the possibility of a handover to an alternative base station 36. Initially, however, connection 33 of communication user 32 to base station 31 is maintained here, but the route planning is adapted to a new route planning 35 in such a way that it no longer passes through the direct line-of-sight between communication partner 32 and base station 31, as a result of which there is also no disconnection.

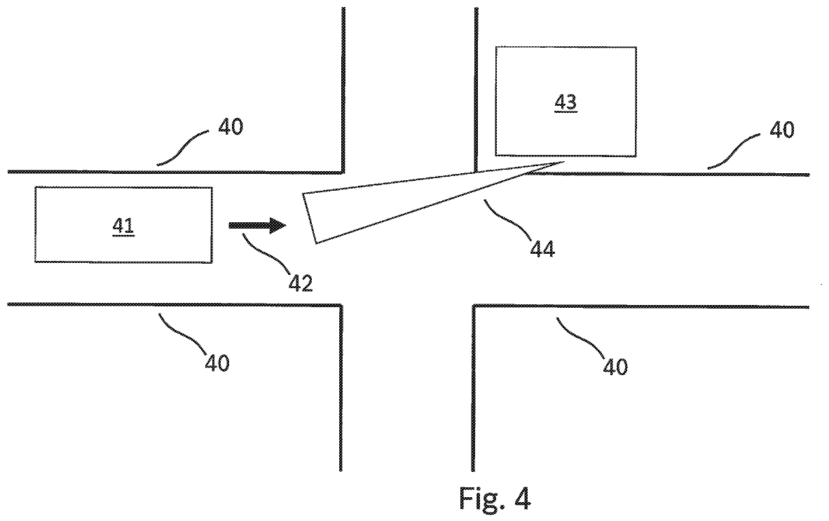

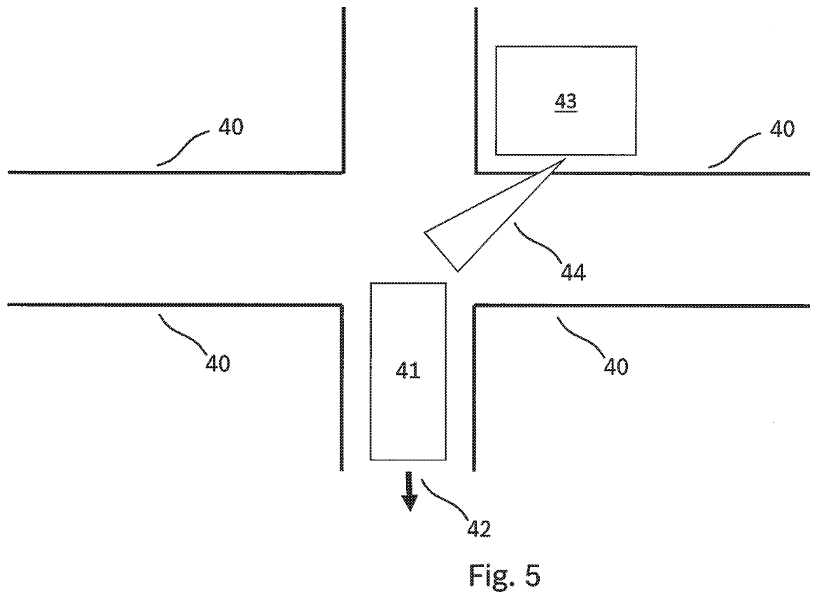

Another exemplary embodiment is shown in FIGS. 4 and 5. As shown in FIG. 4, a unit 41, for example, a transport vehicle AGV guided in an automated manner, which is connected to a base station 43 via a (schematically shown) connection 44, is traveling in factory surroundings within areas delimited by markings 40, and is steered, for example, via the network, along a route 42 toward an intersection. Base station 43 initiates a so-called beam forming process, with the aid of which transmission signal 44 is aimed directly at the unit.

The communication system may then be proactively adapted, provided the speed, travel direction or route of the unit are then known to the predicting processing unit. Thus, it is shown in FIG. 5 that, based on the scenario in FIG. 4, unit 41 traveled along its route 42 over the intersection and that the alignment of beam 44 of base station 43 has been correspondingly adapted, so that the radio connection is always optimal. This adaptation of the communication system to the movement of the element of the surroundings (infrastructure element) in this case did not take place in response to the established movement or to the deterioration of the connection, which generally results in a poorer, because updated, performance, but proactively based on a prognosis of the changed surroundings on the basis of pieces of surroundings information (planned route, historical route data, planned changes of direction, etc.) and, if necessary, on pieces of information of the communication system (possible beam directions and beam intensities, etc.). When relocating the control of the unit (for example, of an AGV) by relocation to an intelligence of the communication system, it is possible with such an approach, for example, to ensure a higher speed of the unit.

What is claimed is:

1. A method for controlling a wireless communication system in first surroundings, comprising:
ascertaining first pieces of information about actual or planned changes of the first surroundings;
ascertaining a future state of the first surroundings on the basis of the first pieces of information to determine a predicted future state; and
adapting the wireless communication system as a function of the predicted future state.

2. The method as recited in claim 1, wherein the first pieces of information include pieces of information about an actual or planned movement of elements of the surroundings.

3. The method as recited in claim 2, wherein the elements include production machines, processing machines, robots, at least partially automated vehicles.

4. The method as recited in claim 1, wherein the first pieces of information include pieces of information about an actual or planned movement of communication users of the communication system.

5. The method as recited in claim 1, further comprising:
detecting first parts of the first pieces of information by sensors corresponding to a visual sensor, a camera, a radar system, a LIDAR system, or by a location-ascertaining sensor system.

6. The method as recited in claim 5, further comprising:
ascertaining second parts of the first pieces of information about pieces of status information or pieces of planning information by elements of the surroundings or by communication users.

7. The method as recited in claim 5, wherein second pieces of information about the communication network corresponding to network traffic or the network infrastructure are ascertained and are taken into consideration during the adaptating of the wireless communication system.

8. The method as recited in claim 1, wherein first pieces of information already ascertained for earlier predictions and stored in a memory are used for ascertaining the predicted future state.

9. The method as recited in claim 1, wherein the predicted future state includes future locations and movements of elements of the surroundings corresponding to production machines, processing machines, robots, or partially automated vehicles.

10. The method as recited in claim 1, wherein the predicted future state includes future locations and movements of communication users.

11. The method as recited in claim 1, wherein the predicted future state includes connection strengths and beam directions of wireless connections in the communication system.

12. The method as recited in claim 1, wherein the predicted future state includes effects on applications in the surroundings corresponding to applications of communication users.

13. The method as recited in claim 1, wherein network guidelines or requirements from applications of communication users are taken into consideration during the adaptating of the wireless communication system.

14. The method as recited in claim 1, wherein base stations or switches or routers of the wireless communication system are adapted.

15. The method as recited in claim 1, wherein a selection of elements of the communication system used is made in which a change of elements of the wireless communication system that are used takes place during the adapting of the wireless communication system.

16. The method as recited in claim 1, wherein the adapting of the wireless communication system includes adapting transmission parameters corresponding to transmission power, emission characteristics, coding methods, or coding rates.

17. A computer program configured to carry out a method for controlling a wireless communication system in first surroundings, the method comprising:
ascertaining first pieces of information about actual or planned changes of the first surroundings;
ascertaining a future state of the first surroundings on the basis of the first pieces of information to determine a predicted future state; and
adapting the wireless communication system as a function of the predicted future state.

18. A processing unit, comprising:
a computer program configured to carry out a method for controlling a wireless communication system in first surroundings, the method comprising:
ascertaining first pieces of information about actual or planned changes of the first surroundings;
ascertaining a future state of the first surroundings on the basis of the first pieces of information to determine a predicted future state; and
adapting the wireless communication system as a function of the predicted future state.
